(19) United States
(12) Patent Application Publication
(10) Pub. No.: US 2007/0118452 A1
(43) Pub. Date: May 24, 2007

(54) Financial Instrument Trading Interface with Dynamic Price Scale

(75) Inventors: Timothy S. Mather, Englewood, CO (US); Michael J. Glista, Homer Glen, IL (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQGT, Inc., Denver, CO (US)

(21) Appl. No.: 11/550,170

(22) Filed: Oct. 17, 2006

Related U.S. Application Data
(63) Continuation-in-part of application No. 11/531,397, filed on Sep. 13, 2006.
(60) Provisional application No. 60/727,748, filed on Oct. 17, 2005.
(60) Provisional application No. 60/772,671, filed on Feb. 13, 2006.
(60) Provisional application No. 60/781,211, filed on Mar. 10, 2006.
(60) Provisional application No. 60/833,095, filed on Jul. 25, 2006.

(51) Int. Cl. G06Q 40/00

(52) U.S. Cl. 705/36 R

(57) ABSTRACT

A method for trading a financial instrument includes displaying a dynamic price scale containing a plurality of prices corresponding to orders for a financial instrument dynamically shifting the prices in the price scale when the inside market changes, displaying a plurality of buy order entry cells aligned with prices in the dynamic price scale and a plurality of sell order entry cells aligned with prices in the dynamic price scale, displaying a static inside market window around prices associated with the inside market, wherein the static inside market window does not move in response to a change in the inside market, and enabling a user to enter a buy or sell order by selecting one of the plurality of buy order entry cells or one of the plurality of sell order entry cells.

### RELATED APPLICATIONS

This application claims the benefit of Provisional Application Nos. 60/727,748, filed on Oct. 17, 2005; 60/772,671, filed on Feb. 13, 2006; 60/781,2111 filed on Mar. 10, 2006; and 60/833,095, filed on Jul. 25, 2006. This application is a continuation-in-part of patent application Ser. No. 11531,397, filed Sep. 13, 2006. All of the foregoing patent applications are hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006 CQG Inc.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange via a network, the trader can obtain real-time or historical financial data, place orders (e.g., market, stop, limit, or stop limit orders) to buy or sell a financial instrument, perforn a wide range of financial analyses, and much more. In addition, data can be presented to the trader in various useful formats, such as graphical or alphanumeric. The manner of presentation of data and the interface through which the trader enters orders to the market are typically very important to traders because they can effect timeliness of data presentation, the timeliness of order entry, the ability of the trader to observe and capitalize on market trends, and so on.

Of course, traders would prefer to be able to predict future prices with a high degree of confidence in order to increase their chances of profitability. Thus, the useful presentation of financial data is critical. In addition, traders prefer a trading interface through which trades can be effectively entered in a visually satisfying manner.

A common trading interface presents the depth of market (DOM) of a financial instrument in a table (referred to as a DOM table), with bid and ask volumes shown at corresponding prices. For example, each ask volume and each bid volume value may be in a row that includes the corresponding price. In most of these interfaces when the inside market changes, the prices remain static, but the volume values shift relative to the prices. If the inside market continues to change in the same direction, eventually the inside market cells will shift off the display, due to the limited display space. A user action is then required to bring the inside market back into view. If the market is trending rapidly, this independent action to re-center the inside market can interfere with the user action required to enter of a new order or modify an existing order.

An order type often used once a position has been established in a market is a trailing stop order. The price of the stop order is continuously adjusted as the market moves in a profitable direction to secure a continuously increasing amount of profit. Many conventional user interfaces for placing or modifying orders in the market require multiple user actions, which inhibit the ease of placing or modifying orders.

In addition, many conventional trading interfaces do not allow for display of financial data in different formats in correspondence with the DDOM table. Thus, traders are typically limited to the data that is shown in the DOM table, without the benefit of other data formats presented in combination with the DOM table.

Furthermore, some DOM table trading interfaces only enable the user to trade through the table using a single click, whereby, with the single click on a trade cell, the trade is entered. While some traders find this mode of trading to be to their advantage, others may find this unappealing because if they accidentally click on a trade cell, the trade is nonetheless entered. As such, some conventional interfaces introduce a relatively high potential for entering unintended trade orders.

### SUMMARY

An embodiment of a system is configured to display a graphical user interface, wherein the graphical user interface comprises an interactive table through which buy and sell orders can be entered. The table presents at least a portion of a depth of market (DOM) of a financial instrument, and includes a dynamic price scale having a plurality of bid prices and a plurality of ask prices. The table further includes a plurality of ask volume values in alignment with corresponding ask prices of the dynamic price scale, and a plurality of bid volume values in alignment with corresponding bid prices of the dynamic price scale. The table further includes a static inside market window framing at least one ask price and one bid price representing the inside market.

The system may be further configured to cause the DOM table to be updated in response to a change in the inside market by shifting the price scale according to the change in the inside market, but keeping the inside market window static.

An embodiment of the graphical user interface may further include a financial information chart presenting financial information in dynamic alignment with the dynamic price scale. The chart may include a plurality of financial bars, wherein a most recent bar is aligned with either the bid price of the inside market or the ask price of the inside market.

The DOM table may further include one or more graphical indicators that indicate buying or selling pressure. Still further, the DOM table may include a plurality of order entry cells aligned with the dynamic price scale enabling the user to enter a trade at a price and volume by entering one or more trade parameters in an associated order entry cell. The system may further be configured to enable a user to enter one or more parameters of a trade by hovering a graphical pointer over a selected trade entry cell and clicking at least once on the selected order entry cell using a clickable input device. Still further, a price and volume of the trade are locked-in when the user hovers the graphical pointer over the selected order entry cell. Yet further, the system may enable the user to enter one or more parameters of an order by dragging and dropping a graphical order ticket at a selected order entry cell.

Various embodiments of the system enable the user to configure an order entry mode, whereby the user selects an order entry mode from a group consisting of a fast click mode, and a drag-and-drop mode. In the fast click mode, a selected price and volume of an order are locked-in when the user hovers a graphical pointer over a selected order entry cell and the order is entered when the user clicks once on the selected order entry cell. In the drag-and-drop mode, the user can define parameters of a trade in an order ticket, drag the order ticket to a selected order entry cell, and drop the order ticket onto the selected order entry cell. In some embodiments of the system, another interface is displayed through which the user can select between a dynamic price scale and a responsive price scale.

Still further, in one or more embodiments of the system, the static inside market window remains at the same location in the DOM table despite changes in the inside market, unless the user moves the static inside market table to another location in the DOM table.

Other embodiments include a computer-implemented method for trading a financial instrument on an electronic exchange, wherein the method includes displaying a dynamic price scale containing a plurality of prices corresponding to orders for a financial instrument, dynamically shifting the prices in the price scale when the inside market changes, displaying a plurality of buy order entry cells aligned with prices in the dynamic price scale and a plurality of sell order entry cells aligned with prices in the dynamic price scale, and displaying a static inside market window around prices associated with the inside market, wherein the static inside market window does not move in response to a change in the inside market. The user can enter a buy or sell order by selecting one of the plurality of buy order entry cells or one of the plurality of sell order entry cells.

In various embodiments of the computer-implemented method the static inside market window only moves if a user moves the static inside market window to another location in the dynamic price scale. The method may still further include enabling the user to reposition the static inside market window to another location in the dynamic price scale.

At least one embodiment of the computer-implemented method further includes displaying a sell order entry axis including the plurality of sell order entry cells aligned with the prices and the volume values, and enabling the user to position a graphical pointer in a selected sell order entry cell to lock in a price for a sell order associated with the selected sell order entry cell.

Various embodiments of the computer-implemented method may further include enabling the user to enter the sell order by clicking at least once in the selected sell order entry cell, and when the user clicks in the selected sell order entry cell, sending the sell order to the electronic exchange at the locked in price, despite a change in the inside market between the time when the price was locked in and the time that the user clicks in the selected sell order entry cell.

Yet another embodiment of the computer-implemented method includes displaying a buy order entry axis including the plurality of buy order entry cells aligned with the prices and the volume values, and enabling the user to position a graphical pointer in a selected buy order entry cell to lock in a price for a buy order associated with the selected buy order entry cell. The computer-implemented method may further include enabling the user to enter the buy order by clicking at least once in the selected buy order entry cell, and when the user clicks in the selected buy order entry cell, sending the buy order to the electronic exchange at the locked in price, despite a change in the inside market between the time when the price was locked in and the time that the user clicks in the selected buy order entry cell.

Various embodiments of the computer-implemented method as include allowing a user to disable the dynamic behavior of the price scale and enable a responsive behavior of the price scale. Still further, the method may include displaying a direction indicator on the price scale, the direction indicator indicating whether there is buying pressure or selling pressure. The computer-implemented method may further include displaying a financial information chart near the price scale, whereby data units in the financial information chart are aligned with prices in the dynamic price scale. In some embodiments, the financial information chart is a financial bar chart, wherein bars of the financial bar chart are aligned with prices of the dynamic price scale. A latest displayed bar on the financial bar chart may be aligned with one or more of the bid price and the ask price of the inside market prices bounded by the static inside market window.

### BRIEF DESCRIPTION OF THE DRAWINGS

FIG. 1 illustrates an exemplary operating environment in which embodiments of the present invention may operate.

FIG. 2 illustrates an embodiment of a trading user interface including a DOM trading table in which the price scale is dynamic and a bar chart displayed in correspondence with the price scale.

FIG. 3 illustrates the embodiment of the user interface of FIG. 2 at a later point in time, wherein the inside market has changed, and the price scale has responsively moved, and the bar chart has shifted along with the price scale.

FIG. 4 illustrates an embodiment of user interface similar to the embodiments of FIGS. 2-3, but where the inside market is displayed at an uncentered, user-selected position in the DOM table.

FIG. 5 illustrates another embodiment of a trading user interface in which the DOM trading table is shown at two points in time, and the user has placed trades, and the user has locked in a price for another trade, but the trade will not be placed until the user commits to the trade.

FIG. 6 illustrates an embodiment of a trading user interface in which the DOM trading table is shown at three points in time, in which the user places trades according to a drag-and-drop mode of trade placement.

FIG. 7 illustrates a user interface through which the user can set parameters to configure the trading interface.

FIG. 8 illustrates an exemplary computing device upon which embodiments of the present invention can operate.

### DETAILED DESCRIPTION

Methods, systems and graphical user interfaces are described for monitoring and/or trading of financial instruments. According to one embodiment, a trading interface for electronic trading of financial instruments is provided which includes a dynamic price scale. For example, conceptually, the inside market, representing the best or highest bid and best or lowest ask price, may be displayed in a static window through which the market for a particular financial instrument is viewed. Within this conceptual framework, a particular trading interface for financial instruments in accordance with one embodiment of the present invention may be said to maintain an inside market window within the center of a vertically or horizontally oriented price scale with the prices dynamically moving up and down according to the market activity for the financial instrument. According to one embodiment, each time the inside market for the financial instrument changes, the prices in the dynamic price scale and the associated depth of market volumes and various other associated market indicators shift up or down relative to the static inside market window depending upon the direction of the trade which caused the inside market to change.

In one embodiment, accuracy and certainty regarding placement of an order to trade a financial instrument in the context of a dynamic price scale are enhanced by providing visual confirmation regarding the currently selected price and locking in the selected price (or alternatively, locking in a particular tick offset from the inside market) despite an inside market change which might occur during order placement.

Briefly, in one embodiment, a novel price chart, consisting of bid/ask range bars that reflect the change of the best bid/ask range or inside market over time which better illustrate short-term historical price and trade volume fluctuations for a financial instrument being monitored, may be appended to a financial trading interface, such as a dynamic price scale trading interface. In accordance with one embodiment of the present invention, a new bar is generated and rendered on the bid/ask range chart responsive to inside market changes. The bid/ask range chart may provide to a trader various visual indications of buying or selling pressure in the market place, permitting the trader to make potentially more profitable trading decisions. In accordance with one embodiment of the present invention, new price and corresponding bid trade volume and ask trade volume data points are generated and rendered on a bid/ask range bar chart according to the various rendering rules.

In accordance with one embodiment of the present invention, a new bid/ask range bar is generated and rendered on the bid/ask range chart responsive to inside market changes. A new bid/ask range bar may be generated if the inside market changes even though there has not been any trading activity. In an alternative embodiment, a new bar may be generated in a manner that is based on a combination of prior bid/ask volume or price levels. The combination may consist of an aggregation over a user-selected collection of the bid/ask ranges resulting from changes in the inside market.

information regarding the distribution of traded volume at a particular price or within a particular price range may be categorized and displayed in bar chart form as “bid volume”, that is, volume traded at the bid price, or “ask volume”, that is, volume traded at the ask price, to illustrate the relative volume of trading activity occurring as favoring either buying or selling. Further, volume traded at the best bid price may be categorized as “up bid volume” or “down bid volume” depending on the direction of the movement of the inside market. Similarly, volume traded at the best ask price may be categorized as “up ask volume” or “down ask volume” depending on the direction of the movement of the inside market.

In one embodiment, each bar in the bar chart corresponds to, or is based upon, a bid/ask range data point. In accordance with various embodiments, a bid/ask range data point includes one or more data values such as, but not limited to, a start time, an open price, a high price, a low price, a close price, a bid trade volume, a bid trade volume due to large trades, an ask trade volume, and an ask trade volume due to large trades. Each data point corresponds to a finite time duration during a trading session or trading sessions.

With more specific reference to the bid/ask range bars, various attributes of the bid/ask range data points can be presented in different ways to convey information to the viewer. By way of example, different colors and/or color intensities and/or the bar widths can be used to indicate bid trade volume and ask trade volume information to the viewer. According to one embodiment, bid trade volume relative to ask trade volume may be communicated to a trader by visually depicting individual bars of the bar chart in two or more different colors and/or multiple intensities and/or multiple bar widths. For example, the proportion of the total volume traded at the bid for a particular bid/ask range bar may be conveyed by coloring a first portion of the bar a first color (e.g., green). Within the first portion, the amount of trading volume attributed to the bid is depicted with shades of the first color (e.g., shades of green) having increasing visual intensity (e.g., brighter shading) associated with corresponding increases in the total volume of the bar. Similarly, the proportion of the total volume traded at the ask for a particular bid/ask range bar may be conveyed by coloring a second portion of the bar a second color (e.g., red). Within the second portion, the amount of trading volume attributed to the ask is depicted with shades of the second color (e.g., shades of red) having increasing visual intensity (e.g., brighter shading) associated with corresponding increases in the total volume of the data point. Similarly, increases in the total volume of a data point may be conveyed to the viewer by increasing the width of the bar.

According to an alternative embodiment, a bid/ask range bar may be assigned a single uniform color depending whether it is determined to reflect buying or selling pressure. For example, if the inside market has moved up and the volume traded at the ask is greater than the volume traded at the bid, then the bar might be colored an intense green reflecting high buying pressure. If the inside market has moved down and the volume traded at the ask is greater than the volume traded at the bid, then the bar might be colored a less intense green reflecting low buying pressure. Similarly, if the inside market has moved down and the volume traded at the bid is greater than the volume traded at the ask, then the bar might be colored an intense red reflecting high selling pressure. If the inside market has moved up and the volume traded at the bid is greater than the volume traded at the ask, then the bar might be colored a less intense red reflecting low selling pressure.

If no trading occurred for a period of time between two bars, the bid/ask range bar corresponding to that time period might be assigned a neutral color such as grey.

According to one embodiment, an end user, such as a trader, may be able to set volume thresholds that are used to determine the intensity of the color and/or the width of the bid/ask range bars. The volume thresholds may be expressed as absolute values, as a percent rank relative to historical volume values, or as percentages of a base volume where the base volume may be expressed as an absolute value or be algorithmically determined, for example, by calculating a median or a moving average of the historical volume values. Other algorithms may be used to determine the base volume. Because the volume thresholds can be quite different for different trading sessions, data may be segregated by session when using the historical data to determine the relative rank or the base volume threshold. The user may also explicitly set the colors that are used to shade the bars at the various traded volume thresholds.

In one embodiment, the bid/ask range data point's open price, high price, low price, close price, mid price, bid trade volume, or ask trade volume, may be used with additional analyses such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

Display or suppression of any of the described graphical user interface screens may be configurable by the end user and/or responsive to end user request.

While, for convenience, embodiments of the present invention are described herein with reference to specific bid/ask range charts, bid/ask volume charts and specific user interface screens for trading financial instruments in the form of dynamic price scales, the techniques described are equally applicable to various other types and structures of charts and trading paradigms.

Exemplary Network Environment

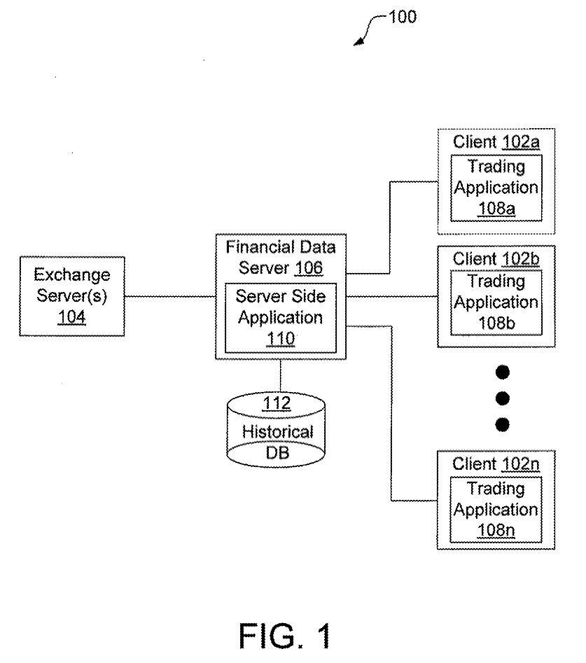

FIG. 1 illustrates an exemplary operating environment 100 in which embodiments of the present invention may be employed. One or more traders use client computers or terminals 102a-n to analyze data and place orders to trade on electronic exchange server(s) 104. Typically, the electronic exchange server(s) 104 are servers associated with the electronic exchange that accept trade orders, provide requested data, provide a substantially real-time stream of bid, ask, and trade prices and volumes, and other data manipulation related to the electronic exchange. The clients 102a-n communicate with a financial data server 106 that facilitates communication of financial data and placement of trade orders.

Trading applications 108a-n operate on clients 102a-n, respectively. Trading applications 108a-n each gather financial data, process the data, present selected data to the trader on a display (not shown), receive input from the trader, and transmit trade orders to the server 106. More specifically, the trading applications 108a-n communicate with a server side application 110. The server side application 110 is operable to obtain selected data from the exchange server(s) 104 and communicate data to and from the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price and volume data. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data which may be used again later. The server 106 may at times remove selected data from the cache, based on caching rules.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as routers, firewalls and network address translators (NATs), may provide for data routing and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed (e.g., streamed) to one or more of the clients 102a-n by the server side application 110.

Exemplary Trading User Interfaces

The trading client presents user interfaces to the user (e.g., trader). The user interfaces are typically graphical and display financial data in one or more formats. The user interfaces also enable the user to enter orders (e.g., buy orders and sell orders). The client application enables the user to configure certain aspects of the user interface, such as the user interface behavior and look. The following description describes a number of embodiments of graphical user interfaces for presenting financial data, enabling placement of trades, and configuring aspects of the client application.

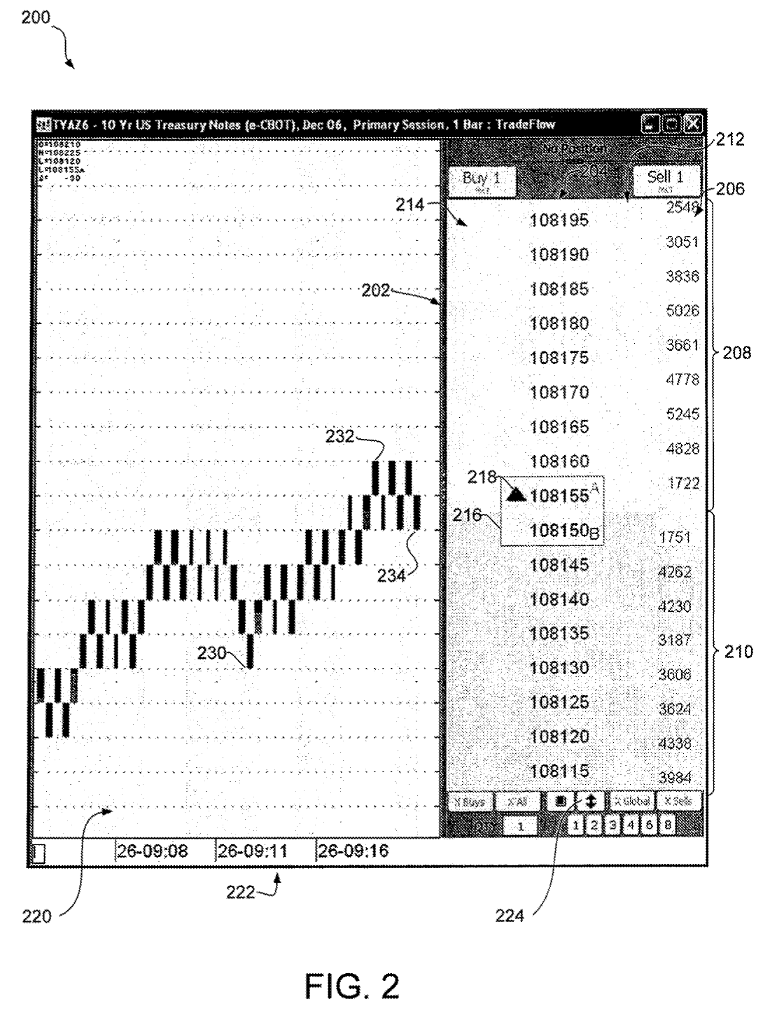

FIG. 2 is a snapshot of a graphical user interface 200 for trading of financial instruments in accordance with one embodiment. Because FIG. 2 is a snapshot, it illustrates information for one selected financial instrument at a particular instant in time. The values shown in FIG. 2 are for illustrative purposes only. In actual operation, the user can select a different financial instrument and the information in the user interface 200 will be substantially continuously updated as streaming data are received by the client application.

The trading interface 200 includes a depth of market (DOM) table 202 through which the user can view at least a portion of the DOM associated with the selected financial instrument. The user can also place trades through the DOM trading interface 202. The DOM table 202 includes a price scale 204 along an axis. The price scale 204 includes a plurality of prices at which orders have been entered into the market. The DOM table 202 also includes a plurality of volume values positioned along a volume axis 206.

The prices in the price scale 204 are aligned with the volume values of the volume axis 206. In other words, each price is aligned with an associated volume value. For example, in FIG. 2, the price 108160 is aligned with volume 4828, which means that 4828 contracts are being offered at a price of 108160.

Referring to the volume axis 206, some of the volumes are ask volumes 208, and others of the volumes are bid volumes 210. Ask volumes 208 are the volumes of contracts being offered in the market to sell at the associated prices. For example, in FIG. 2, 5245 contracts are being offered for sale at a price of 108165. The bid volumes 210 are the volumes of contracts being bid in the market to buy at the associated prices. For example, in FIG. 2, 4262 contracts are being bid at a price of 108145.

The DOM table 202 also includes a sell order entry axis 212 and a buy order entry axis 214. In the sell order entry axis 212 are a plurality of sell order entry cells aligned with associated prices and ask volumes 208. In other words, each sell order entry cell is aligned with a order price. The user can select one of the sell order entry cells to enter a sell order. Similarly, the buy order entry axis 214 includes a plurality of buy order entry cells, where each buy order entry cell is aligned with an order price.

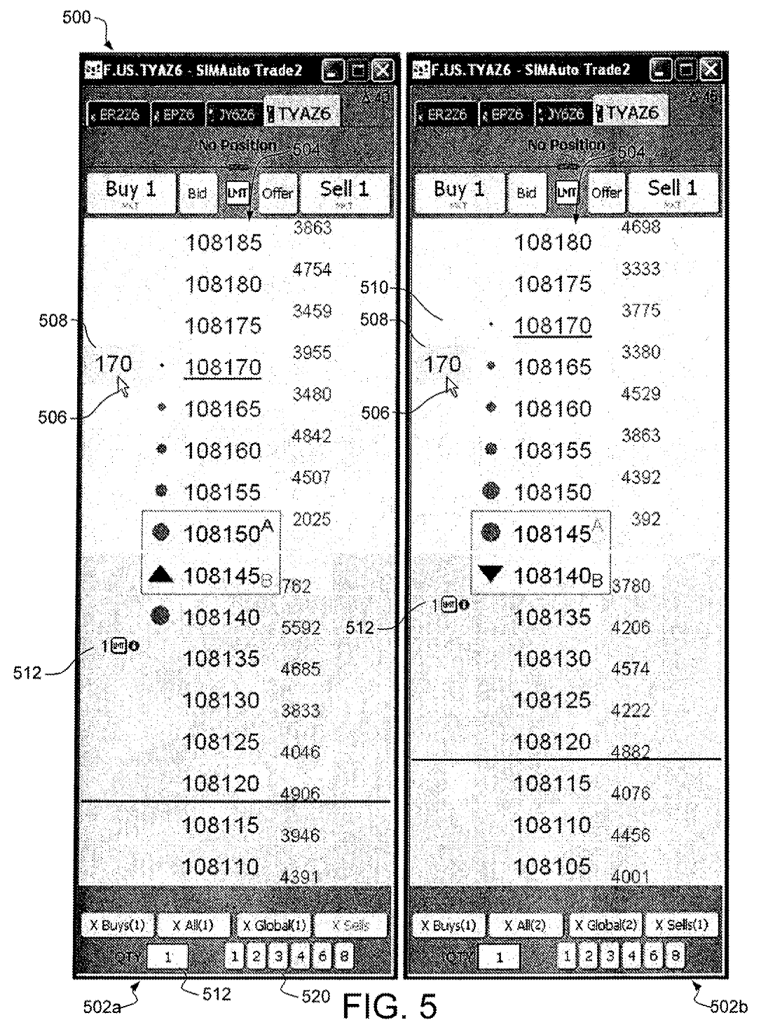

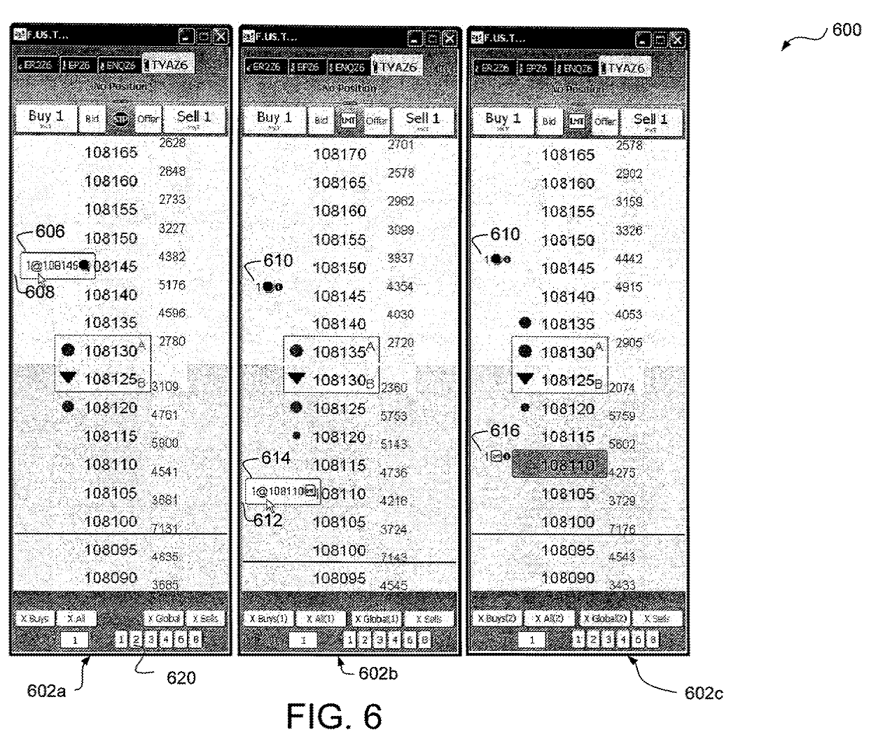

Through the buy and sell order entry cells, the user can enter a stop or limit order to buy or sell at the selected price. When placing an order, the user selects an order cell which establishes a desired order price and an associated order type. In various embodiments, the order can be placed in one of multiple order entry modes. Exemplary order entry modes are discussed further below in reference to FIG. 5 and FIG. 6.

Continuing with FIG. 2, in various embodiments, an inside market window 216 is displayed which frames the prices of the price display associated with the inside market. In the scenario of FIG. 2, the inside market window 216 frames the current best ask price of 108155, and the current best bid price of 108150, Also shown in the inside market window is a direction indicator 218, which indicates whether there is net buying or selling pressure in the market. In the example of FIG. 2, the direction indicator 218 indicates that the price pressure is upward because the last trade occurred at the ask price, which may be associated with a higher buying pressure relative to selling pressure.

As is known in the art, orders are continuously entered to the electronic exchange throughout a trading session, and the inside market changes over time. With reference to the DOM table 202, in embodiments described herein, the price scale 204 is dynamic, meaning that the price scale 204 shifts up or down according to changes in the inside market.

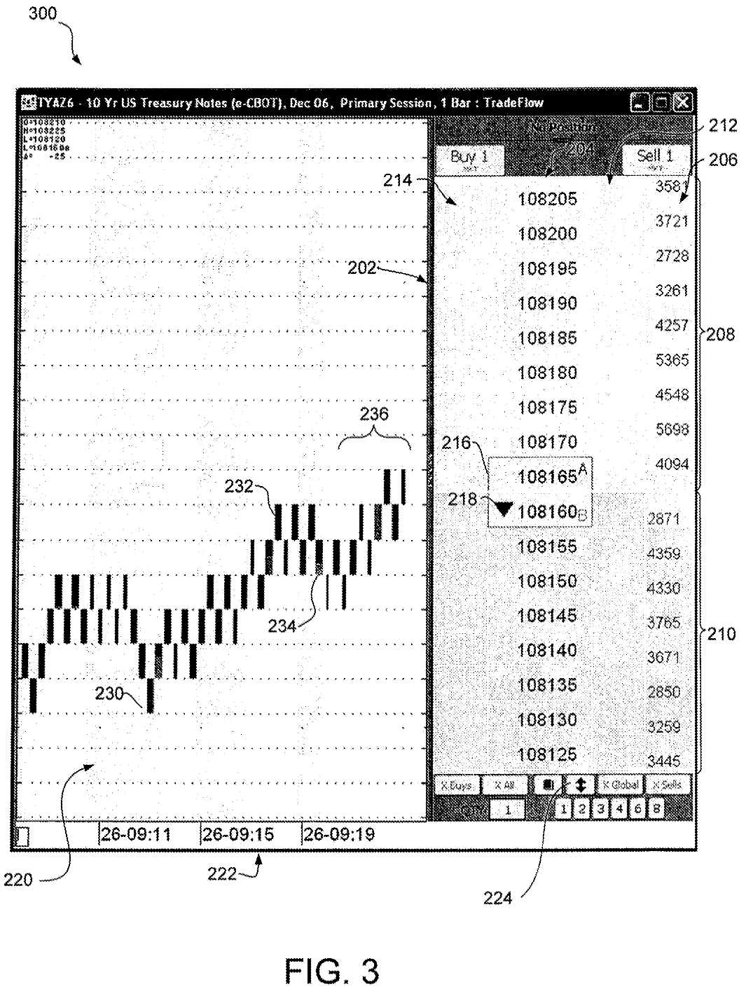

To illustrate the dynamic nature of the price scale 204, FIG. 3 presents another snapshot of the trading interface 200 at an later time in trading. In this example, the inside market has changed from an ask price of 108155 and a bid price of 108150 (shown in FIG. 2) to an ask price of 108165 and a bid price of 108160 (shown in FIG. 3). In addition, the direction indicator 218 indicates that the buying/selling pressure direction has changed from that shown in FIG. 2.

In various embodiments, the inside market window 216 is static, which means that the inside market window 216 does not move in response to price changes in the inside market. For examples as shown in FIG. 2 and FIG. 3, although the inside market has changed, the inside market window 216 has not moved. In this embodiment, the centering button 224 is shown with a double-headed arrow pointing outwards indicating that the inside market is centered in the trading interface window.

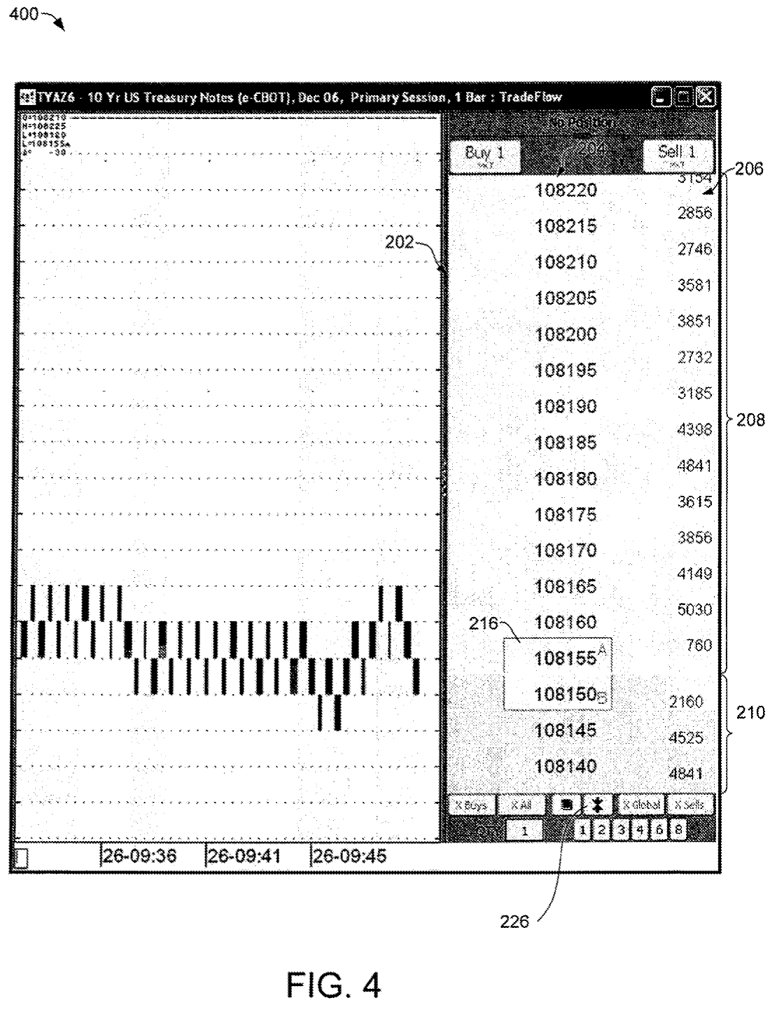

In various embodiments, the user can move the static inside market window 216. This is illustrated in FIG. 4, which illustrates the trading interface 200 at a later time than in FIGS. 2-3. In FIG. 4 the user has moved the static inside market window 216 down to a user-selected position in the dynamic price scale 204. In this illustrative scenario, the inside market window 216 has been moved to a non-central position in the dynamic price scale 204. After the user moves the static inside market window 216, the static inside market window 216 remains in the selected location, despite changes in the inside market. By moving the static inside market window 216, the user can choose to see more or less of the ask side (or bid side) of the depth of market. This can be advantageous if the user expects the market to move in one direction or another. In the scenario of FIG. 4, the user has selected a location for the static inside market window 216 that enables the user to view more of the ask side of the depth of market, as shown by the ask portion 208 of the DOM table 202. In this embodiment, the centering button 224 in FIG. 4 is shown with a double-headed arrow pointing inwards indicating that the inside market is not centered in the trading interface window. When the user presses the centering button 224, the inside market is returned to the center of the trading interface window.

Referring again to FIG. 2, the illustrated embodiment can include a financial chart, such as a bar chart 220, aligned with the price scale 204. The bar chart 220 includes a plurality of bars 230 that reflect various financial information at associated times shown in a time scale 222. Times on the time scale 222 go from youngest on the right side of the bar chart 220 to oldest on the left side of the bar chart 220. Thus, when a new bar is created, such as bar 234, it is displayed on the right side of the bar chart 220, with all the other bars shifting to the left, and the leftmost bar disappearing from the display. Various systems and methods for generating and displaying financial bars and bar charts are discussed in detail in co-pending and co-owned patent application entitled “System and Method for Determining Data Points for Financial Bar Charts and Their Presentation”, filed Sep. 13, 2006, with patent application Ser. No. 11/531,397 (Atty. Docket No. 339371), and which is incorporated herein by reference for all purposes.

In various embodiments, the bar chart 220 is dynamically aligned with the dynamic price scale 204, and a new bar is displayed when the inside market changes. As such, the bars are aligned with corresponding prices in the price scale 204, and when the inside market changes, the next bar is aligned with the ask price and the bid price of the inside market. Thus, when a new bar is present (i.e,. when the inside market changes), all the bars 230 in the bar chart 220 may shift up or down, according to how the price scale 204 shifts. The shift in the positions of the bars can be illustrated by viewing FIG. 2 and FIG. 3 in sequence. The reader will observe that in this particular scenario, a bar labeled 232 in FIG. 2 has shifted down in the bar chart 220 when shown at the later time in FIG. 3. Of course, all the other bars also shifted down as the inside market prices moved higher. Furthermore, in the time elapsed between FIG. 2 and FIG. 3, the bar labeled 234 has been updated and six additional bars 236 generated by the market activity have been added to the bar chart in FIG. 3.

Turning now to FIG. 5, it is illustrated how a user can place orders to trade in a financial market according to one embodiment. FIG. 5 illustrates a first mode of order placement that can be available in trading interfaces of the present invention. The order placement mode presented in FIG. 5 is referred to as “fast-click” mode. Briefly, in fast-click mode, the user locks in a price by hovering a graphical pointer (e.g., a mouse arrow) over either an buy order entry cell or a sell order entry cell. While hovering, the price associated with the selected cell is “locked”, meaning that the order price remains the same even though the inside market might change. When the user “clicks” (e.g., depresses a mouse button once) the selected cell, the order is placed at the price the user locked into with the hover. As such, a selected order price can be confirmed by the user prior to placing the order.

Referring specifically to the example illustrated in FIG. 5, a snapshot of a DOM table 502a at a first moment in time is shown on the left, while a snapshot of the DOM table 502b at a later moment in time is shown on the right. Between the first moment in time, and the second moment in time, the inside market has moved down (i.e., the price scale 504 has shifted up).

In DOM table 502a, the user has positioned a graphical pointer 506 over a buy order entry cell 508 corresponding to price 108170. The graphical pointer 506 is hovering over the cell 508. When the graphical pointer 506 begins to hover over the cell 508, the price 108170 is locked in. In this embodiment, the cell 508 is shaded and the last three digits of the price are inserted into the cell 508 to indicate to the user that the once is locked in.

When the inside market changes and the price scale 504 shifts up as illustrated in DOM table 502b, the cell 508 remains shaded and the locked in price of 170 continues to be displayed in the cell 508. This indicates that the price of 108170 is locked in, despite the change in the inside market. In one embodiment, clicking on a cell in which a price has been locked in causes the order to be placed at that price. Thus, in FIG. 5, if the user decides to place the order at a price of 108170, the user clicks on the cell 508. After the user clicks on the cell 508, a buy stop order with a quantity of one is entered into the exchange and an stop order icon representing the placed stop order appears in the buy cell 510 opposite the placed order price. The limit order icon 512 in FIG. 5 illustrates a previously placed limit order in the market to buy 1 contract at a price of 108135.

In one embodiment, movement of the graphical pointer 506 out of a DOM table causes a previously locked in price to be unlocked. Thus, in FIG. 5, if the user decides not to place the order at a price of 108170, the user moves the graphical pointer 506 out of the buy order cell 508 in DOM table 502b.

In the illustrated embodiment, the quantity of an order is set by selecting quantity buttons 520. The quantity that is selected appears in a quantity window 512. The next order placed will have a quantity equal to the quantity in the quantity window 512.

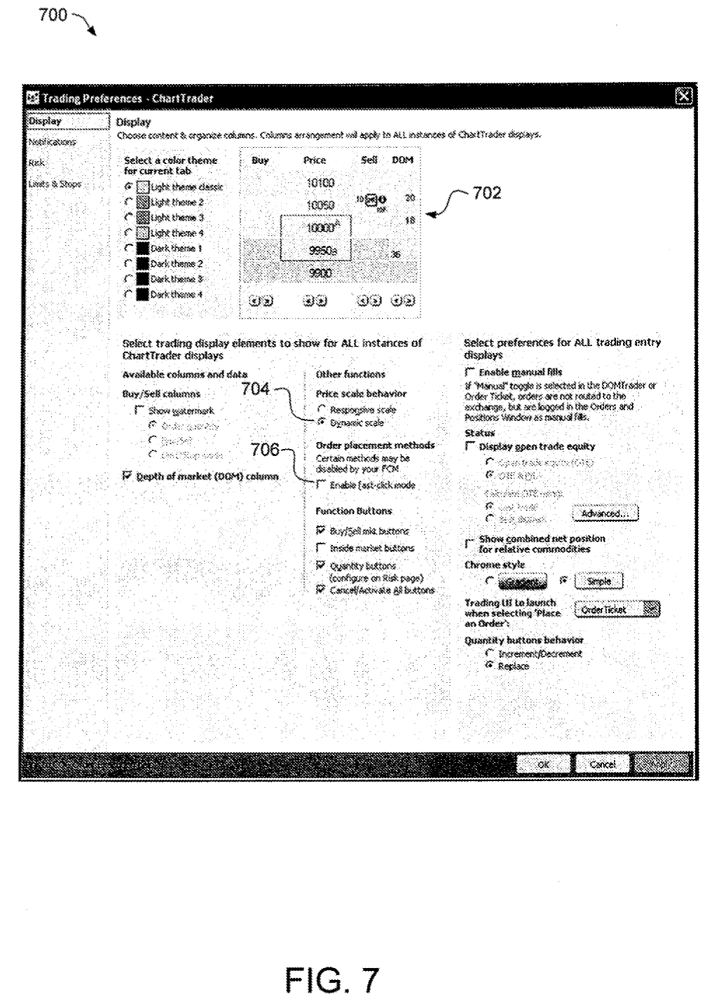

Referring now to FIG. 6, another mode of trade order entry is illustrated. This mode of order entry may be referred to as the “drag-and-drop” mode. Briefly, in the drag-and-drop mode, the user sets the quantity parameter and clicks and drags a selected price to either a buy order entry cell or a sell order entry cell. A graphical “order ticket” is created on the display with the parameters of the order shown in the ticket. When the order ticket is dropped, the order is placed. In one embodiment, the drag-and-drop mode is the default mode of order entry, and the user can change the mode to fast-click using a user interface such as the user interface shown in FIG. 7, discussed further below.

With more specific reference to the illustrative scenario of FIG. 6, there are three snapshots of DOM tables 602a-602c, with the oldest DOM table 602a shown on the left and the youngest DOM table 602c shown on the right. To place an order, the user first sets the order quantity using quantity selectors 610. The user then drags from a selected price in the dynamic price scale 604. When the user selects a price, such as 108145, and begins to drag the price toward either a buy order entry cell or a sell order cell, a graphical order ticket 606 with a locked in price is displayed. In the illustrated scenario, the user drags the selected price 108145 toward the buy order entry cell 608. In this case, the buy order is a stop order, as indicated by the stop sign, because the buy price is greater than the inside market bid price. To place the order into the market, the order ticket is dropped in cell 608. When the order has been accepted by the exchange and acknowledged, a stop order icon appears in the buy cell 610 corresponding to the order price 108145.

As another illustrative example, in DOM table 602b, the user has selected price 108110 and has dragged the price toward buy order entry cell 612. An order ticket 614 is automatically presented that includes the quantity, price and trade type (limit). In this example, the order type associated with the order ticket 614 is a limit order because the order price is less than the inside market bid price. In both exemplary DOM tables 602a-602b, the buy order is placed when the user drops the order ticket in the buy order entry cell 612.

Turning to FIG. 7, a user interface 700 is shown there, through which the user can set configuration parameters of the trading interface. A color theme selector 702 is displayed. With the color theme selector 702, the user can choose colors associated with different portions of DOM trading tables.

With price scale behavior selectors 704, the user can choose between a dynamic price scale behavior, or a responsive price scale behavior. Thus, the user can choose to have the price scale behave dynamically, or not. Using an order entry mode selector 706, the user can choose to have orders placed according to the fast-click mode, or not. When the order entry mode selector 706 is “unchecked”, the mode is the drag-and-drop mode described above.

Exemplary Computing Device

Embodiments of the present invention include various steps, which are described herein. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware or human representatives of the parties or entities involved in the transaction.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g, a modem or network connection).

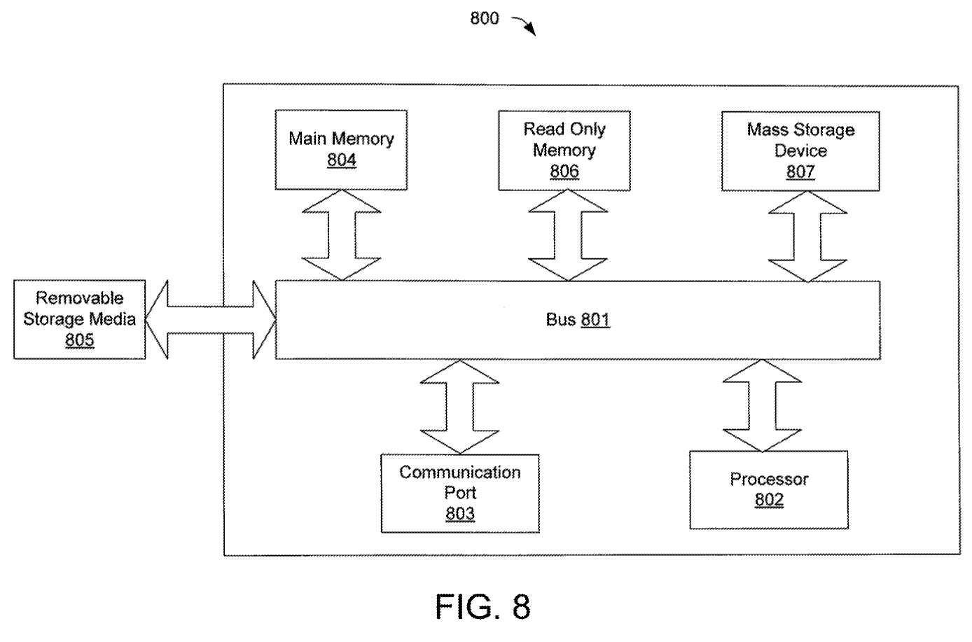

FIG. 8 is a schematic diagram of a computing device 800 upon which a server or client side financial trading and/or analysis application may execute. According to the present example, the computing device 800 includes a bus 801 at least one processor 802, at least one communication port 803, a main memory 804, a removable storage media 805 a read only memory 806, and a mass storage 807. Processor(s) 802 can be any know processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 803 may be chosen depending on a network such a Local Area Network (LAN), Wide Area Network (WAN), or any network to which the computing device 800 connects. The computing device 800 may be in communication with peripheral devices (not shown) such as, but not limited to, printers, speakers, cameras, microphones, or scanners.

Main memory 804 can be Random Access Memory (RAM), or any other dynamic storage device(s) commonly known in the art. Read only memory 806 can be any static storage device(s) such as Programmable Read Only Memory (PROM) chips for storing static information such as instructions for processor 802. Mass storage 807 can be used to store information and instructions. For example, hard disks such as the Adaptec® family of SCSI drives, an optical disc, an array of disks such as RAID, such as the Adaptec family of RAID drives, or any other mass storage devices may be used.

Bus 801 communicatively couples processor(s) 802 with the other memory, storage and communication blocks. Bus 801 can be a PCI/PCI-X or SCSI based system bus depending on the storage devices used. Removable storage media 805 can be any kind of external hard-drives, floppy drives, IOMEGA® Zip Drives, Compact Disc—Read Only Memory (CD-ROM), Compact Disc—Re-Writabte (CD-RW), Digital Video Disk—Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While, for convenience, embodiments of the present invention are described herein with reference to specific data processing algorithms, bid/ask range charts, bid/ask volume charts and specific user interface screens for trading financial instruments in the form of dynamic price scales, the techniques described are equally applicable to various other types and structures of charts and trading paradigms.

Terminology

Brief definitions of terms used throughout this application and attached appendix are given below.

The term “financial instrument” generally refers to anything that can be either bought or sold by specifying a price and a quantity. Examples of financial instruments include, but are not limited to., stocks, bonds, mutual funds, Exchange-Traded Funds (EFTs), stock futures, commodity futures, stock options, commodity options and the like.

The term “trader” generally refers to anyone using an input device, computerized or otherwise, to place orders to trade, either to buy or to sell a specific quantity of a financial instrument, into a market place.

The phrase “price bar” for a particular financial instrument generally refers to the graphical representation of a data entity that includes of four price values: an open price, which is the first price registered, a high price, which is the highest price registered for the discrete duration of the bar; a low price, which is the lowest price registered for the discrete duration of the bar; and a close price, which is the last price registered for the discrete duration of the bar. Prices considered in constructing the data entity may include bids, asks and trades or just trades exclusively.

The phrase “bid/ask range bar” for a particular financial instrument refers to the graphical representation of a data entity that includes trade volume information as well as an open price, a high price, a low price and a close price.

The phrase “ask trade volume” for a particular financial instrument generally refers to the number of contracts or shares traded or, in an alternative embodiment, the number of trades, that occurred at the ask price for the financial instrument within the particular financial instrument price range.

The phrase “bid trade volume” for a particular financial instrument generally refers to the number of contracts or, shares traded or in an alternative embodiment, the number of trades that occurred at the bid price for the financial instrument within the particular financial instrument price range.

The phrases “bid/ask range” or “inside market” for a particular financial instrument refers to the price region bounded by the currently established best or highest bid price and the currently established best or lowest ask price.

The term “static” as used, for example, in the phrase “static inside market window” refers to a fixed or stationary condition of the inside market window in response to price changes in the inside market. However, the term static does not preclude the repositioning of the inside market window on the display screen due to a user action.

The phrase “pre-open period” refers to the period prior to the opening of a financial market for trading during which the financial exchange accepts limit orders and publishes the order book.

The phrase “the market is crossed” refers to a market state where the best bid is greater than or equal to the best ask.

The phrase “bar chart” refers to a graph with one or more window panes that share a common horizontal time scale. Each window pane may display one or more data points for each time point and may have one or more independent value scales.

The phrases “chart overlay” or “overlay” refers to the graphical display of one data set in the same window pane as another data set or other data sets.

The phrase “the user clicks” generally refers to a user interaction with a mouse, a trackball, or a similar device whereby the action consists of the user pressing a button down with the graphical pointer positioned at a desired location or over a desired object and immediately thereafter releasing the button. Unless otherwise specified, when the device has more than one button, the button referred to is the left button for right-handed operation or the right button for left-handed operation.

The phrase “drag and drop” generally refers to a user interaction with a mouse, a trackball, or a similar device whereby the drag action is initiated when the user presses a button down with the graphical pointer positioned over the desired object and a drop is executed when the user releases the button with the graphical pointer located over the destination. Unless otherwise specified, when the device has more than one button, the button referred to is the left button for right-handed operation or the right button for left-handed operation.

The term “responsive” includes completely or partially responsive.

The terms “connected,” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification or Appendix states a component or feature “may”, “can”, “could”, or “might” be included or have a characteristic, that particular component or feature is not required to be included or have the characteristic.

1. A system for trading financial instruments on an electronic exchange, the system comprising:
a display device operable to display a graphical user interface;
a display input/output device in communication with the display device;
a microprocessor in communication with the display input/output device and operable to execute instructions stored in memory;
a memory having microprocessor executable instructions, wherein the microprocessor executable instructions cause the microprocessor to communicate display data to the display input/output device to cause a graphical user interface to be displayed on the display device, wherein the graphical user interface comprises an interactive table through which buy and sell orders can be entered, the table presenting at least a portion of a depth of market (DOM) of a financial instrument, the table including a dynamic price scale having a plurality of bid prices and a plurality of ask prices, the table further including a plurality of ask volume values in alignment with corresponding ask prices of the dynamic price scale, the table further including a plurality of bid volume values in alignment with corresponding bid prices of the dynamic price scale, the table further including a static inside market window framing at least one ask price and one bid price representing the inside market, and
the microprocessor executable instructions further causing the microprocessor to update the DOM table in response to a change in the inside market by shifting the price scale according to the change in the inside market but keeping the inside market window static.

2. The system as recited in claim 1, wherein the graphical user interface further comprises a financial information chart presenting financial information in dynamic alignment with the dynamic price scale.

3. The system as recited in claim 2, wherein the chart comprises a bar chart including a plurality of financial bars, wherein a most recent bar is aligned with either the bid price of the inside market or the ask price of the inside market.

4. The system as recited in claim 1, wherein the DOM table further comprises one or more graphical indicators that indicate buying or selling pressure.

5. The system as recited in claim 1, wherein the DOM table further comprises a plurality of order entry cells aligned with the dynamic price scale enabling the user to enter a trade at a price and volume by entering one or more trade parameters in an associated order entry cell.

6. The system as recited in claim 5, wherein the user can enter one or more parameters of a trade by hovering a graphical pointer over a selected trade entry cell and clicking at least once on the selected order entry cell using a clickable input device.

7. The system as recited in claim 6, wherein a price and volume of the trade are locked in when the user hovers the graphical pointer over the selected order entry cell.

8. The system as recited in claim 5, wherein the user can enter one or more parameters of an order by dragging and dropping a graphical order ticket at a selected order entry cell.

9. The system as recited in claim 5, wherein the user can configure a order entry mode, whereby the user selects a order entry mode from a group consisting of:
a fast click mode, wherein a selected price and volume of an order are locked in when the user hovers a graphical pointer over a selected order entry cell, and wherein the order is entered when the user clicks once on the selected order entry cell; and
a drag-and-drop mode, wherein the user is enabled to define parameters of a trade in an order ticket, drag the order ticket to a selected order entry cell, and drop the order ticket onto the selected order entry cell.

10. The system as recited in claim 1, wherein the microprocessor executable instructions further cause the microprocessor to communicate with the display input/output device to display another interface on the display, through which the user can select between a dynamic price scale and a responsive price scale.

11. The system as recited in claim 1, wherein the static inside market window remains at the same location in the DOM table despite changes in the inside market, unless the user moves the static inside market table to another location in the DOM table.

12. A computer-implemented method for trading a financial instrument on an electronic exchange, the financial instrument having an inside market, the method comprising:
displaying a dynamic price scale containing a plurality of prices corresponding to orders for a financial instrument;
dynamically shifting the prices in the price scale when the inside market changes;
displaying a plurality of buy order entry cells aligned with prices in the dynamic price scale and a plurality of sell order entry cells aligned with prices in the dynamic price scale;
displaying a static inside market window around prices associated with the inside market, wherein the static inside market window does not move in response to a change in the inside market; and enabling a user to enter a buy or sell order by selecting one of the plurality of buy order entry cells or one of the plurality of sell order entry cells.

13. The computer-implemented method as recited in claim 12, wherein the static inside market window only moves if a user moves the static inside market window to another location in the dynamic price scale.

14. The computer-implemented method as recited in claim 13, further comprising enabling the user to reposition the static inside market window to another location in the dynamic price scale.

15. The computer-implemented method as recited in claim 12, further comprising:
displaying a sell order entry axis including the plurality of sell order entry cells aligned with the prices and the volume values;
enabling the user to position a graphical pointer in a selected sell order entry cell to lock in a price for a sell order associated with the selected sell order entry cell.

16. The computer-implemented method as recited in claim 15, further comprising:
enabling the user to enter the sell order by clicking at least once in the selected sell order entry cell;
when the user clicks in the selected sell order entry cell, sending the sell order to the electronic exchange at the locked in price, despite a change in the inside market between the time when the price was locked in and the time that the user clicks in the selected sell order entry cell.

17. The computer-implemented method as recited in claim 12, further comprising:
displaying a buy order entry axis including the plurality of buy order entry cells aligned with the prices and the volume values,
enabling the user to position a graphical pointer in a selected buy order entry cell to lock in a price for a buy order associated with the selected buy order entry cell.

18. The computer-implemented method as recited in claim 17, further comprising:
enabling the user to enter the buy order by clicking at least once in the selected buy order entry cell;
when the user clicks in the selected buy order entry cell, sending the buy order to the electronic exchange at the locked in price, despite a change in the inside market between the time when the price was locked in and the time that the user clicks in the selected buy order entry cell.

19. The computer-implemented method as recited in claim 12, further comprising allowing a user to disable the dynamic behavior of the price scale and enable a responsive behavior of the price scale.

20. The computer-implemented method as recited in claim 12, further comprising displaying a direction indicator on the price scale, the direction indicator indicating whether there is buying pressure or selling pressure.

21. The computer-implemented method as recited in claim 12, further comprising displaying a financial information chart near the price scale, whereby data units in the financial information chart are aligned with prices in the dynamic price scale.

22. The computer-implemented method as recited in claim 21, wherein the displaying a financial information chart comprises displaying a financial bar chart, wherein bars of the financial bar chart are aligned with prices of the dynamic price scale.

23. The computer-implemented method as recited in claim 22, wherein a latest displayed bar on the financial bar chart is aligned with one or more of the bid price and the ask price of the inside market prices bounded by the static inside market window.
